(19) United States
(12) Patent Application Publication
(10) Pub. No.: US 2026/0344768 A1
(43) Pub. Date: Nov. 5, 2026

(54) MICROWAVE HEATING ASSEMBLY AND AEROSOL GENERATING DEVICE

(71) Applicant: SMOORE INTERNATIONAL HOLDINGS LIMITED, Grand Cayman (KY)

(72) Inventor: Jing DU, Shenzhen (CN)

(73) Assignee: SMOORE INTERNATIONAL HOLDINGS LIMITED, Grand Cayman (KY)

(21) Appl. No.: 19/721,187

(22) Filed: Jun. 26, 2026

Related U.S. Application Data
(63) Continuation of application No. PCT/CN2024/118610, filed on Sep. 12, 2024.

(30) Foreign Application Priority Data
Dec. 27, 2023 (CN) 202311834926.6

(51) Int. Cl. A24F 40/46; A24F 40/20; A24F 40/51

(52) U.S. Cl. CPC A24F 40/46; A24F 40/51; A24F 40/20

(57) ABSTRACT

A microwave heating assembly and an aerosol generating device are provided. The microwave heating assembly includes an outer conductor unit, an inner conductor unit, and a sealing member. A cavity is provided between an open end and a closed end of the outer conductor unit. The inner conductor unit is arranged in the cavity. A fixed end of the inner conductor unit is connected to the closed end of the outer conductor unit. A free end of the inner conductor unit extends towards the open end of the outer conductor unit. A recess is provided in the surface of the free end of the inner conductor unit. The recess is concaved towards the closed end of the outer conductor unit. The sealing member is arranged in the cavity, and is connected to the outer conductor unit. An aerosol generating substrate is at least partially accommodated in the recess.

### RELATED APPLICATION

The present application is a continuation of International Patent Application No. PCT/CN2024/118610, filed on Sep. 12, 2024, which claims priority to Chinese Patent Application No. 202311834926.6, filed on Dec. 27, 2023. The entire disclosure of the prior applications is hereby incorporated by reference.

### TECHNICAL FIELD

The present disclosure relates to the technical field of aerosol generation technologies, and in particular, to a microwave heating assembly and an aerosol generating device.

### BACKGROUND

An aerosol generating device can heat an aerosol generating substrate to form through microwave heating. The aerosol generating device includes a microwave heating assembly. The microwave heating assembly usually includes an outer conductor unit, a resonant cavity defined by the outer conductor unit, and an inner conductor unit arranged in the resonant cavity. The size of the inner conductor unit and the outer conductor unit will affect the designed resonant frequency of the resonant cavity. To reach the compliant designed resonant frequency (usually 2.4 GHz to 2.5 GHz), the designed volume of the cavity is large, which is unconducive to the miniaturization of the aerosol generating device. In addition, the temperature of the outer wall of the resonant cavity is often low, and the aerosols in the resonant cavity are likely to generate a condensate when coming into contact with the cooler outer wall. The condensate flows down into the bottom core position of the resonant cavity, causing contamination and affecting the normal operation of the device.

### SUMMARY

To solve the technical problem of at least one defect in the prior art, the present disclosure provides an improved microwave heating assembly and an aerosol generating device.

A microwave heating assembly is provided. The microwave heating assembly includes an outer conductor unit, an inner conductor unit, and a sealing member, where the outer conductor unit has the open end, the closed end, and a cavity provided between the open end and the closed end of the outer conductor unit; the inner conductor unit is arranged in the cavity, and has the fixed end and the free end, the fixed end of the inner conductor unit is connected to the closed end of the outer conductor unit, and the free end of the inner conductor unit extends towards the open end of the outer conductor unit; a recess is provided in the surface of the free end of the inner conductor unit, and the recess is concaved towards the closed end of the outer conductor unit; and the sealing member is arranged in the cavity, and is connected to the outer conductor unit.

The microwave heating assembly further includes a sensor arranged outside the cavity, a first through hole is provided in the outer conductor unit, and the first through hole provides gas communication between the sensor and the cavity.

The outer conductor unit includes the first side wall and the first bottom wall that are connected, the first side wall and the first bottom wall jointly define the cavity, and the first through hole is provided in the first side wall.

An extension portion protruding in a direction far away from the cavity is formed on the outer conductor unit, and the first through hole extends through the extension portion.

An accommodating area for accommodating an aerosol generating substrate is defined between the recess bottom surface of the recess and the open end of the outer conductor unit, and the first through hole provides gas communication between the sensor and the accommodating area.

The microwave heating assembly further includes a fixing frame for accommodating an aerosol generating substrate, the sealing member is arranged between the fixing frame and the recess, a second through hole is provided in the sealing member, and the second through hole is provided in correspondence to the first through hole.

The sealing member has the cylindrical shape, and includes the second side wall and the second bottom wall that are connected, and the second side wall abuts against the outer conductor unit; and/or
the sealing member is at least partially arranged in the recess.
the microwave heating assembly further includes a probe arranged in the cavity; and
the probe has the elongated shape, the one end of the probe penetrates the sealing member and the inner conductor unit, and the other end of the probe extends to the open end of the outer conductor unit. Preferably, the inner conductor unit includes a conductor post and a conductor disk; the conductor post includes the fixed end and the free end, and the fixed end of the conductor post is connected to the closed end of the outer conductor unit; the conductor disk is connected to the free end of the conductor post, and the end, farthest away from the conductor post, of the conductor disk is provided with the free end of the inner conductor unit; and the recess is provided in the surface, oriented away from the conductor post, of the conductor disk.

The present disclosure further provides an aerosol generating device. The aerosol generating device includes a microwave generating unit and the microwave heating assembly according to any one described above, where the microwave heating assembly further includes a microwave feeding unit connected to an outer conductor unit, and the microwave feeding unit is connected to the microwave generating unit, and configured to feed a microwave generated by the microwave generating unit into a cavity.

The present disclosure has at least the following beneficial effects: the aerosol generating substrate is at least partially accommodated in the recess. Thus, the height of the cavity can be reduced, and miniaturization of the aerosol generating device is facilitated. The sealing member arranged in the cavity can be used for intercepting a condensate in the cavity. Thus, a risk that the condensate flows to the bottom of the cavity and contaminates other important components is reduced.

### BRIEF DESCRIPTION OF THE DRAWINGS

The present disclosure will be further described below in conjunction with accompanying drawings and examples. In the figures:

FIG. 1 is a schematic diagram of an overall structure of a microwave heating assembly according to an aspect of the present disclosure;

FIG. 2 is a schematic diagram of a plan view of FIG. 1;

FIG. 3 is a sectional view along A-A of FIG. 2;

FIG. 4 is a schematic diagram of structural comparison of a microwave heating assembly in the prior art and a microwave heating assembly according to an aspect of the present disclosure; and

FIG. 5 is a schematic structural diagram of an exploded view of the microwave heating assembly shown in FIG. 1.

### DETAILED DESCRIPTION

To more clearly understand the technical features, objectives, and effects of the present disclosure, specific implementations of the present disclosure will be described in detail herein with reference to the accompanying drawings. It should be noted that “first” and “second” are merely for the convenience of distinguishing two parts, and cannot be understood as limitation to the present disclosure.

An aerosol generating device according to the present disclosure may use microwaves to heat an aerosol generating substrate 2, atomize the aerosol generating substrate and generate aerosols for a user to be puffed. In an aspect, the aerosol generating substrate 2 is a solid aerosol generating substrate 2, such as a processed plant leaf product. It can be understood that in some other embodiments, the aerosol generating substrate 2 may alternatively be a liquid aerosol generating substrate 2.

The aerosol generating device may include a microwave generating device (not shown) and a microwave heating assembly 1. The microwave generating device may generate the microwaves. When the device is used, the aerosol generating substrate 2 is loaded into the microwave heating assembly 1. The microwave heating assembly 1 is connected to the microwave generating device to receive the microwaves, to form a microwave field. The microwave field may act on the aerosol generating substrate 2, to implement microwave heating on the aerosol generating substrate.

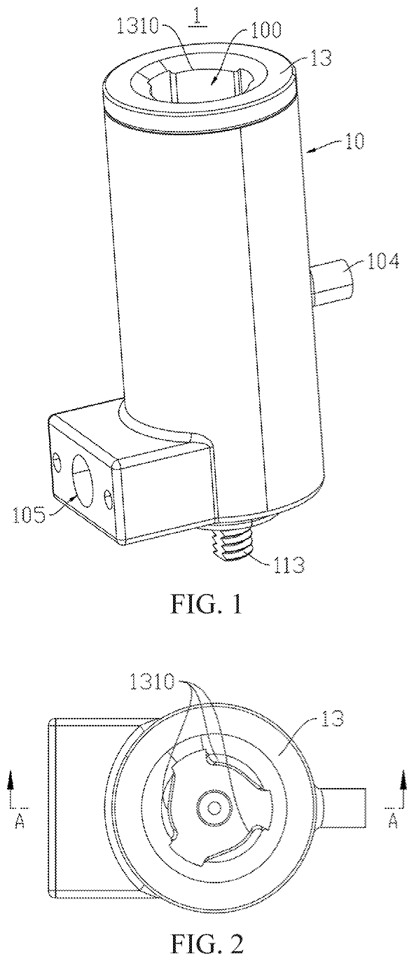

As shown in FIG. 1 to FIG. 3, a microwave heating assembly 1 according to an aspect of the present disclosure includes an outer conductor unit 10, an inner conductor unit 11, and a sealing member 12. The outer conductor unit 10 has a cylindrical shape. The outer conductor unit 10 has an open end, a closed end, and a cavity 100 provided between the open end and the closed end of the outer conductor unit 10, and the cavity 100 is a semi-closed cavity. The inner conductor unit 11 is arranged in the cavity 100, and has the fixed end and the free end, the fixed end of the inner conductor unit 11 is connected to the closed end of the outer conductor unit 10, and the free end of the inner conductor unit 11 extends towards the open end of the outer conductor unit 10.

The microwave heating assembly 1 may further include a microwave feeding unit connected to the outer conductor unit 10, and the microwave feeding unit is connected to a microwave generating unit, and configured to feed a microwave generated by the microwave generating unit into the cavity 100.

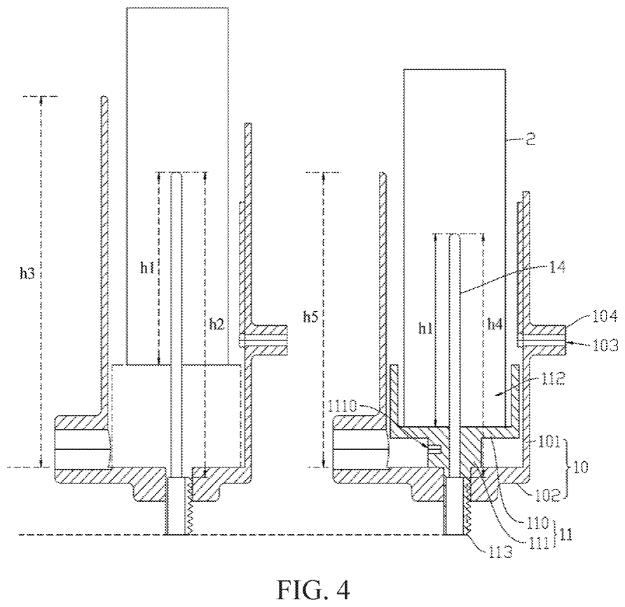

With reference to FIG. 4, the right of FIG. 4 is a schematic structural diagram of a microwave heating assembly according to an aspect of the present disclosure. The microwave heating assembly 1 further includes a probe 14 arranged in the cavity 100. The probe 14 has the elongated shape, one end of the probe penetrates the sealing member 12 and the inner conductor unit 11, and the other end of the probe extends to the open end of the outer conductor unit 10. In addition, the probe 14 and the sealing member 12 are in interference fit to achieve a desirable sealing effect. When the aerosol generating substrate 2 is loaded into the cavity 100, the portion, extending to the open end of the outer conductor unit 10, of the probe 14 penetrates the interior of the aerosol generating substrate 2, and is used for generating a microwave field, to heat and atomize the aerosol generating substrate 2.

Preferably, the shape of the end portion of the upper end of the probe 14, that is, the end portion of the end, extending to the open end of the outer conductor unit 10, of the probe 14, may include one of a plane, a sphere, an ellipsoid, a cone, or a frustum. The frustum shape is preferably selected, such that a local field strength can be improved, and then the atomization speed of the aerosol generating substrate can be accelerated.

A recess 112 is provided in the surface of the free end of the inner conductor unit 11, and the recess 112 is concaved towards the closed end of the outer conductor unit 10. The recess 112 is used for accommodating at least part of the aerosol generating substrate 2. That is, the aerosol generating substrate 2 may be partially accommodated in the recess 112 or all accommodated in the recess 112.

As shown on the left of FIG. 4, in the prior art, after an aerosol generating substrate 2 is loaded into a cavity 100, the bottom of the aerosol generating substrate is directly supported by the surface of the free end of an inner conductor unit 11. As a result, a technical problem is caused as follows: for providing a proper microwave field, the depth h1 of the probe 14 penetrating the aerosol generating substrate 2 is not allowed to be too less. Especially, when the length of the aerosol generating substrate 2 is increased and the position of the aerosol generating substrate 2 is unchanged, the depth h1 of the probe 14 penetrating the aerosol generating substrate 2 and the length h2 of the probe 14 are also increased, for providing the proper microwave field. When the length h2 of the probe 14 is great, the height h3 of the resonant cavity is correspondingly great. As a result, miniaturization of the cavity 100 becomes difficult, and miniaturization of the aerosol generating device cannot be implemented advantageously. In addition, with the increase in the depth h1 of the probe 14 penetrating the aerosol generating substrate 2, a resonant frequency in the resonant cavity is likely to fail to fall within a compliant frequency band, usually 2.4 GHz to 2.5 GHz.

As shown on the right of FIG. 4, in the present disclosure, the aerosol generating substrate 2 is at least partially accommodated in the recess 112. Thus, while the length of the aerosol generating substrate 2 is increased, the height of the position of the aerosol generating substrate in the cavity 100 can be reduced, and the proper microwave field can be still guaranteed while h1 maintains unchanged. Compared with the prior art on the left, the depth h1 of the probe 14 penetrating the aerosol generating substrate 2 is unchanged, but the length h4 of the probe 14 is less than h2, the length h4 of the probe 14 is effectively reduced, the height h5 of the cavity 100 is less than h3, and the height of the cavity 100 is reduced effectively. Thus, the microwave heating assembly 1 of the present disclosure can effectively reduce the height of the cavity 100, and facilitate the miniaturization of the aerosol generating device.

In addition, the depth h1 of the probe 14 penetrating the aerosol generating substrate 2 also affects a designed resonant frequency of the cavity 100. The designed resonant frequency needs to fall within the compliant frequency band, usually 2.4 GHz to 2.5 GHz. In the prior art, when the length of the aerosol generating substrate 2 is increased, to provide the proper microwave field, the depth h1 of the probe 14 penetrating the aerosol generating substrate 2 is also increased in a case that the position of the aerosol generating substrate 2 is unchanged. Thus, the designed resonant frequency value of the cavity 100 is increased, and it is difficult for the cavity 100 to reach a compliant designed resonant frequency.

As shown in Table 1 below, through tests, an aerosol generating device in the prior art has an operating frequency of 2.56 GHz, greater than the compliant frequency band, at a minimum dielectric constant, and a reflection coefficient of −12.5 db, and has an operating frequency of 2.27 GHz, less than the compliant frequency band, at a maximum dielectric constant, and a reflection coefficient of −3.6 db. The reflection coefficient is used for representing an energy utilization rate. The reflection coefficient represents the ratio of a reflected wave to an incident wave. The smaller the reflection coefficient value is, the higher the energy utilization rate is, and the higher the feeding efficiency is. At the maximum dielectric constant, the reflection coefficient of the aerosol generating device is merely −3.6 db. During a heating process, a change amplitude of the operating frequency of the device is 2.56 GHz-2.27 GHz=0.29 GHz.

TABLE 1

| | Operating | S11 (reflection |
|---|---|---|
| Heating process | frequency | coefficient) |
| Minimum dielectric constant | 2.56 GHz | −12.5 db |
| Maximum dielectric constant | 2.27 GHz | −3.6 db |

As shown in Table 2 below again, the aerosol generating device of an aspect of the present disclosure has an operating frequency of 2.48 GHz, falling within the compliant frequency band, at a minimum dielectric constant, and a reflection coefficient of −27 db, and has an operating frequency of 2.40 GHz, falling within the compliant frequency band, at a maximum dielectric constant, and a reflection coefficient of −13 db. During a heating process, a change amplitude of the operating frequency of the device is 2.48 GHz-2.40 GHz=0.08 GHz.

TABLE 2

| | Operating | S11 (reflection |
|---|---|---|
| Heating process | frequency | coefficient) |
| Minimum dielectric constant | 2.48 GHz | −27 db |
| Maximum dielectric constant | 2.40 GHz | −13 db |

In combination with Table 1 and Table 2 above, it can be seen that compared with the prior art, in the present disclosure, the aerosol generating substrate 2 is at least partially accommodated in the recess 112, and when the length of the aerosol generating substrate 2 is increased, the proper microwave field can be still guaranteed while h1 maintains unchanged. Thus, the change amplitude of the operating frequency of the device can be reduced advantageously from 0.29 GHz to 0.08 GHz, and the operating frequency of the device can fall within the compliant frequency band 2.4 GHz to 2.5 GHz. In addition, the reflection coefficient is greatly reduced, and higher energy utilization rate and feeding efficiency are achieved.

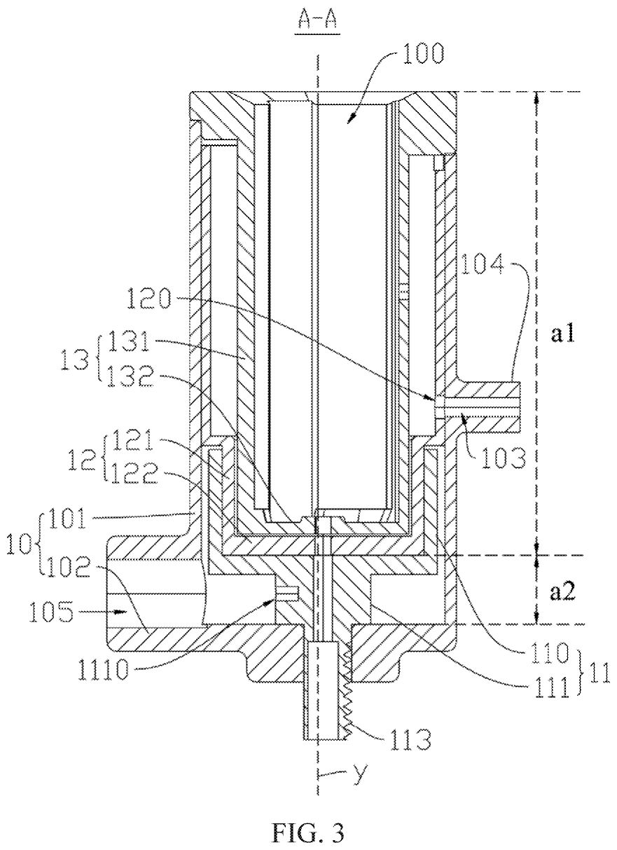

As shown in FIG. 3, the sealing member 12 is arranged in the cavity 100, and is hermetically connected to the outer conductor unit 10. Then, the sealing member 12 may divide the cavity 100 into an upper area a1 and a lower area a2 that are hermetically isolated from each other. A condensate in the upper area a1 is intercepted by the sealing member 12. Thus, the condensate in the upper area a1 can be prevented from flowing to the lower area a2 of the cavity 100, and a risk that the condensate flows to the bottom of the cavity 100 and contaminates other important components is reduced.

To sum up, the present disclosure has the following beneficial effects: the aerosol generating substrate 2 is at least partially accommodated in the recess 112. Thus, the height of the cavity 100 can be reduced, and miniaturization of the aerosol generating device is facilitated. The sealing member 12 arranged in the cavity 100 can be used for intercepting the condensate in the cavity 100. Thus, the risk that the condensate flows to the bottom of the cavity 100 and contaminates other important components is reduced.

Further, the microwave heating assembly 1 further includes a sensor, not shown, arranged outside the cavity 100. As shown in FIG. 3, a first through hole 103 is provided in the outer conductor unit 10, and the first through hole 103 provides gas communication between the sensor and the cavity 100. Specifically, the first through hole 103 may provide communication between the cavity 100 and the outside atmosphere, and the sensor may be arranged in the first through hole 103. Alternatively, the sensor may be arranged at the side, farthest away from the cavity 100, of the first through hole 103. The sensor may be a microphone, a Micro-Electro-Mechanical System (MEMS), an air flow sensor, etc. When the aerosol generating device is used, a puff action of a user causes a pressure change in the cavity 100, the pressure change can be sensed by the sensor, and then some intelligent control based on the sensor can be implemented. For example, power-on and power-off of the inner conductor unit 11 are controlled based on the pressure change in the cavity 100.

As shown in FIG. 3, the outer conductor unit 10 includes the first side wall 101 and the first bottom wall 102 that are connected, and the first side wall 101 and the first bottom wall 102 jointly define the cavity 100. The first through hole 103 is provided in the first side wall 101. It is clear that the first through hole 103 may alternatively be provided in the first bottom wall 102.

As shown in FIG. 3, an extension portion 104 protruding in a direction far away from the cavity 100 is formed on the outer conductor unit 10, and the first through hole 103 extends through the extension portion 104. Specifically, the extension portion 104 has the first end connected to the outer conductor unit 10 and the second end farthest away from the cavity 100. The first through hole 103 extends from the second end of the extension portion 104 to the first end of the extension portion and then communicates with the cavity 100.

As shown in FIG. 3, an accommodating area for accommodating at least part of an aerosol generating substrate 2 is defined between the recess bottom surface of the recess 112 and the open end of the outer conductor unit 10, and reference can be made to a scope of the upper area a1 for a scope of the accommodating area. The first through hole 103 provides gas communication between the sensor and the accommodating area. That is, the first through hole 103 is located above the inner conductor unit 11. Thus, the sensor can sense an atmospheric pressure change in the accommodating area, to sense an atmospheric pressure change around the aerosol generating substrate 2. The atmospheric pressure change around the aerosol generating substrate 2 can be associated with the puff action of the user, and intelligent control triggered by the puff action can be implemented.

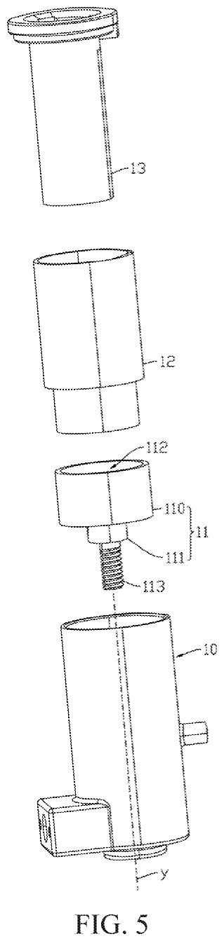

As shown in FIG. 3 and FIG. 5, the microwave heating assembly 1 further includes a fixing frame 13 for accommodating an aerosol generating substrate 2. The sealing member 12 is arranged between the fixing frame 13 and the recess 112. A second through hole 120 is provided in the sealing member 12, and the second through hole 120 is provided in correspondence to the first through hole 103 in the outer conductor unit 10. Specifically, the second through hole 120 and the first through hole 103 may be located at the same height, and communicate opposite with each other. Thus, the first through hole 103 and the second through hole 120 jointly provide gas communication between the sensor and the accommodating area. The fixing frame 13 is used for accommodating the aerosol generating substrate 2, and provides an air inflow channel for the aerosol generating substrate 2. Under the puff action of the user, ambient air enters the aerosol generating substrate 2 through the air inflow channel in the fixing frame 13, and is mixed with aerosols generated by the aerosol generating substrate 2, for the user to be puffed. Thus, puff resistance can be reduced effectively and the temperature of the aerosols puffed by the user can be lowered effectively. The fixing frame 13 is in direct contact with the aerosol generating substrate 2, the condensate is likely to be accumulated, and the sealing member 12 can intercept the condensate flowing out of the fixing frame 13.

As shown in FIG. 3 and FIG. 5, the sealing member 12 has the cylindrical shape, and includes the second side wall 121 and the second bottom wall 122 that are connected. The second side wall 121 and the second bottom wall 122 define a semi-closed first accommodating cavity for accommodating the fixing frame 13. The fixing frame 13 also has the cylindrical shape, and the cylindrical fixing frame 13 includes the third side wall 131 and the third bottom wall 132 that are connected. The third side wall 131 and the third bottom wall 132 define a semi-closed second accommodating cavity for accommodating the aerosol generating substrate 2. Preferably, the second bottom wall 122 of the sealing member 12 is connected to and in direct contact with the recess bottom wall of the recess 112, and the third bottom wall 132 of the fixing frame 13 is connected to and in direct contact with the second bottom wall 122 of the sealing member 12. Thus, the height of the aerosol generating substrate 2 in the cavity 100 can be reduced to the greatest extent, and a reduction in the length of the probe 14 can be facilitated.

As shown in FIG. 1 and FIG. 2, a plurality of positioning ribs 1310 evenly distributed in the circumferential direction of the third side wall are arranged on the third side wall 131 of the fixing frame 13. The positioning ribs 1310 are used for clamping the aerosol generating substrate 2 located in the second accommodating cavity, especially when the aerosol generating substrate 2 is in a solid state such as an aerosol generating product. In addition, at least some air inflow channels are defined between adjacent positioning ribs 1310, to make ambient air to be sucked into the bottom of the aerosol generating substrate 2 advantageously, and then enter the aerosol generating substrate 2, to be mixed with the aerosols generated through microwave heating.

As shown in FIG. 5, the cross section of the recess 112, the cross section of the sealing member 12, and the cross section of the fixing frame 13 have a circular shape. The inner diameter of the recess 112 is greater than the outer diameter of the sealing member 12, and the inner diameter of the sealing member 12 is greater than the outer diameter of the fixing frame 13. Thus, the sealing member 12 may be put in the recess 112 first, and then the fixing frame 13 may be put in the sealing member 12. In an aspect, the recess 112, the sealing member 12, and/or the fixing frame 13 may alternatively have other shapes certainly. The cross section of the recess 112, and the cross section of the sealing member 12, and/or the fixing frame 13 may alternatively have other regular or irregular shapes, such as a square, instead of the circular shape.

As shown in FIG. 3 and FIG. 5, the inner conductor unit 11 includes a conductor post 111 and a conductor disk 110. The conductor post 111 includes the fixed end and the free end, and the fixed end of the conductor post 111 is connected to the closed end of the outer conductor unit 10. The conductor disk 110 is connected to the free end of the conductor post 111, and the end, farthest away from the conductor post 111, of the conductor disk 110 is provided with the free end of the inner conductor unit 11. The recess 112 is provided in the surface, oriented away from the conductor post 111, of the conductor disk 110. With reference to FIG. 4, the probe 14 has the elongated shape, the one end of the probe penetrates the third bottom wall 132 of the fixing frame 13, the second bottom wall 122 of the sealing member 12, and the conductor post 111, and the other end of the probe extends to the open end of the outer conductor unit 10. Specifically, the fixed end of the conductor post 111 is in ohmic contact with the closed end of the outer conductor unit 10, and the conductor disk 110 is in ohmic contact with the free end of the conductor post 111. Preferably, the central axis of the conductor post 111 and the central axis of the conductor disk 110 coincide with the central axis y of the cavity 100. The central axis y of the cavity 100 may be consistent with the direction in which the aerosol generating substrate 2 is loaded into the cavity 100.

The conductor post 111 may have the columnar shape, and the end (bottom end), farthest away from the open end of the outer conductor unit 10, of the conductor post is the fixed end of the inner conductor unit 11, and is fixed to the closed end of the outer conductor unit 10. The end (top end), closest to the open end, of the conductor post is the free end of the inner conductor unit 11, and extends to the open end of the outer conductor unit 10. The diameter of the conductor post 111 is less than the inner diameter of the outer conductor unit 10. It can be understood that the conductor post 111 is not limited to the cylindrical shape, and may alternatively have a square columnar shape, an elliptical columnar shape, a stepped columnar shape, and other irregular columnar shapes. In addition, the bottom end of the conductor post 111 is further provided with an axially extending screw 113, and the screw 113 may be integrated with the conductor post 111. A mounting hole extending through the first bottom wall 102 is provided in the first bottom wall 102 of the outer conductor unit 10, and the screw 113 is in threaded fit with the mounting hole, to fix the conductor post 111 to the first bottom wall 102 of the outer conductor unit 10, and form reliable ohmic contact between the conductor post 111 and the outer conductor unit 10.

As shown in FIG. 3, an insertion hole 1110 is further provided in the conductor post 111. The insertion hole 1110 is used for being in fit with a microwave feeding unit, to implement microwave conduction. Specifically, the microwave feeding unit may include a radio frequency connector not shown. The microwave feeding unit may be a standard or nonstandard radio frequency connector. For example, the radio frequency connector may be a standard SMP-JYD radio frequency connector. A feeding hole 105 is provided in the first side wall 101 of the outer conductor unit 10. The radio frequency connector partially extends into the feeding hole 105 and is in insertion fit with the insertion hole 1110 in the conductor post 111. In addition, the radio frequency connector is further in ohmic contact with the first side wall 101 of the outer conductor unit 10, thus the microwave generated by the microwave generating unit is fed into the cavity 100. The insertion hole 1110 may be a blind hole, a straight columnar channel, and extend radially inside the conductor post 111 along the outer peripheral wall of the conductor post 111. Preferably, the diameter of the insertion hole 1110 is adapted to the diameter of an inner conductor of the radio frequency connector.

The conductor disk 110 is used for microwave conduction, and can further increase inductance and capacitance, match the resonant frequency, and facilitate further reduction in the size of the cavity 100. The conductor disk 110 may have the disk shape, and have the diameter greater than the diameter of the conductor post 111. The conductor disk 110 may be integrated with the conductor post 111 or may be in ohmic contact with the conductor post 111.

The conductor post 111, the conductor disk 110, and/or the outer conductor unit 10 may be made from metal materials or other highly conductive materials. With the outer conductor unit 10 as an example, the outer conductor unit 10 may include one or more of gold, silver, copper, aluminum, iron, a gold-containing alloy, an aluminum-containing alloy, a copper-containing alloy, an iron-containing alloy, and stainless steel. Alternatively, the outer conductor unit 10 may alternatively include a nonmetallic body and a metal coating arranged on the outer layer of the nonmetallic body.

The probe 14 may be made from a conductive metal material integrally, preferably stainless steel, an aluminum alloy, or copper. It can be understood that the probe 14 is not limited to being made from the conductive material integrally, or may be produced by plating the outer surface of a non-conductive body with a conductive coating. The conductive coating is preferably a silver coating or a gold coating plated.

The examples described above are merely preferred implementations of the present disclosure, and are specifically described in detail, but cannot be constructed as limitation to the scope of the patent for the present disclosure as a result. It should be noted that for those of ordinary skill in the art, the technical features described above can be freely combined, and a plurality of variations and improvements can be further made without departure from concepts of the present disclosure, and such combinations, variations, and improvements should fall within the protection scope of the present disclosure. Thus, all equivalent transformations and modifications made within the scope of the claims of the present disclosure should fall within the scope of the claims of the present disclosure.

What is claimed is:

1. A microwave heating assembly comprising:
an outer conductor unit including an open end and a closed end, a cavity being formed between the open end and the closed end;
an inner conductor unit being arranged in the cavity, a fixed end of the inner conductor unit being connected to the closed end of the outer conductor unit, and a free end of the inner conductor unit extending towards the open end of the outer conductor unit;
a recess being provided in a surface of the free end of the inner conductor unit, and the recess being concaved towards the closed end of the outer conductor unit; and
a sealing member being arranged in the cavity, and the sealing member being connected to the outer conductor unit.

2. The microwave heating assembly of claim 1, further comprising:
a sensor being arranged outside the cavity, a first through hole being provided in the outer conductor unit, and the first through hole providing air communication between the sensor and the cavity.

3. The microwave heating assembly of claim 2, wherein
the outer conductor unit comprises a first side wall and a first bottom wall, the first side wall and the first bottom wall jointly define the cavity, and the first through hole is provided in the first side wall.

4. The microwave heating assembly of claim 2, wherein an extension portion protruding in a direction far away from the cavity is formed on the outer conductor unit, and the first through hole extends through the extension portion.

5. The microwave heating assembly of claim 2, further comprising:
an accommodating area, for accommodating an aerosol generating substrate, being defined between the recess bottom surface of the recess and the open end of the outer conductor unit, and wherein the first through hole provides air communication between the sensor and the accommodating area.

6. The microwave heating assembly of claim 2, wherein
the microwave heating assembly further comprises a fixing frame for accommodating an aerosol generating substrate,
the sealing member is arranged between the fixing frame and the recess, a second through hole is provided in the sealing member, and the second through hole corresponds to the first through hole.

7. The microwave heating assembly of claim 1, wherein
the sealing member is in a cylindrical shape, the sealing member comprises a second side wall and a second bottom wall;
the second side wall abuts against the outer conductor unit; and/or
the sealing member is at least partially arranged in the recess.

8. The microwave heating assembly of claim 1, further comprising:
a probe being arranged in the cavity; and
wherein the probe has an elongated shape, one end of the probe penetrates both the sealing member and the inner conductor unit, and another end of the probe extends to the open end of the outer conductor unit.

9. The microwave heating assembly of claim 1, wherein
the inner conductor unit comprises a conductor post and a conductor disk;
the conductor post comprises the fixed end and the free end, and the fixed end of the conductor post is connected to the closed end of the outer conductor unit;
the conductor disk is connected to the free end of the conductor post; and
the recess is provided in the surface, oriented away from the conductor post of the conductor disk.

10. An aerosol generating device comprising:
a microwave generating unit;
a microwave heating assembly including
an outer conductor unit including an open end and a closed end, a cavity being formed between the open end and the closed end,
an inner conductor unit being arranged in the cavity, a fixed end of the inner conductor unit being connected to the closed end of the outer conductor unit, and a free end of the inner conductor unit extending towards the open end of the outer conductor unit,
a microwave feeding unit being connected to an outer conductor unit,
a recess being provided in a surface of the free end of the inner conductor unit, and the recess being concaved towards the closed end of the outer conductor unit, and
a sealing member being arranged in the cavity, and the sealing member being connected to the outer conductor unit; and
wherein the microwave feeding unit is connected to the microwave generating unit, the microwave feeding unit is configured to feed a microwave generated by the microwave generating unit into the cavity.

11. The aerosol generating device of claim 10, the microwave heating assembly further comprising:
a sensor being arranged outside the cavity, a first through hole being provided in the outer conductor unit, and the first through hole providing air communication between the sensor and the cavity.

12. The aerosol generating device of claim 11, wherein
the outer conductor unit comprises a first side wall and a first bottom wall, the first side wall and the first bottom wall jointly define the cavity, and the first through hole is provided in the first side wall.

13. The aerosol generating device of claim 11, wherein an extension portion protruding in a direction far away from the cavity is formed on the outer conductor unit, and the first through hole extends through the extension portion.

14. The aerosol generating device of claim 11, further comprising:
an accommodating area, for accommodating an aerosol generating substrate, being defined between the recess bottom surface of the recess and the open end of the outer conductor unit, and wherein the first through hole provides air communication between the sensor and the accommodating area.

15. The aerosol generating device of claim 11, wherein
the microwave heating assembly further comprises a fixing frame for accommodating an aerosol generating substrate,
the sealing member is arranged between the fixing frame and the recess, a second through hole is provided in the sealing member, and the second through hole corresponds to the first through hole.

16. The aerosol generating device of claim 10, wherein
the sealing member is in a cylindrical shape, the sealing member comprises a second side wall and a second bottom wall;
the second side wall abuts against the outer conductor unit; and/or
the sealing member is at least partially arranged in the recess.

17. The aerosol generating device of claim 10, further comprising:
a probe being arranged in the cavity; and
wherein the probe has an elongated shape, one end of the probe penetrates both the sealing member and the inner conductor unit, and another end of the probe extends to the open end of the outer conductor unit.

18. The aerosol generating device of claim 10, wherein
the inner conductor unit comprises a conductor post and a conductor disk;
the conductor post comprises the fixed end and the free end, and the fixed end of the conductor post is connected to the closed end of the outer conductor unit;
the conductor disk is connected to the free end of the conductor post; and
the recess is provided in the surface, oriented away from the conductor post of the conductor disk.
